(19) United States
(12) Patent Application Publication
(10) Pub. No.: US 2011/0095972 A1
(43) Pub. Date: Apr. 28, 2011

(54) ELECTROPHORETIC DISPLAY DEVICE

(75) Inventors: LI-JIA YAN, Shenzhen City (CN); CHUN-WEI PAN, Tu-Cheng (TW); KUAN-HONG HSIEH, Tu-Cheng (TW)

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/845,701

(22) Filed: Jul. 28, 2010

(30) Foreign Application Priority Data
Oct. 27, 2009 (CN) 200910308898.8

(51) Int. Cl. G09G 3/34

(52) U.S. Cl. 345/107

(57) ABSTRACT

An electrophoretic display device includes pixel electrodes, a transparent electrode, and an electrophoretic ink layer. The electrophoretic ink layer includes a transparent film. Grooves are defined on the transparent film. Each groove is arranged between one of the pixel electrodes and the transparent electrode, and includes suspension fluid, and charged pigment particles dispersed in the suspension fluid. When application of an electric field between one of the pixel electrodes and the transparent electrode causes movement of the charged pigment particles of one of the grooves corresponding to the pixel electrode, and the groove displays a corresponding color.

### BACKGROUND

1. Technical Field

The present disclosure relates to display devices and, more particularly, to an electrophoretic display device.

2. Description of Related Art

Electrophoretic display devices have been the subject of intense research and development for a number of years. Electrophoretic display devices have attributes of good brightness and contrast, wide viewing angles, state bistability (the term “bistability” is used herein in its conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times), and low power consumption when compared with liquid crystal displays. A typical electrophoretic display device is a microcapsule-type electrophoretic display device, in which particle-containing fluid is confined within the walls of a large number of small capsules. However, the production process of the microcapsule-type electrophoretic display device is complex. It is desirable to provide a new type of electrophoretic display device.

### BRIEF DESCRIPTION OF THE DRAWINGS

The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, cross-sectional view of an electrophoretic display device in accordance with an exemplary embodiment.

FIG. 2 is a schematic, planar view of the electrophoretic display device of FIG. 1.

FIG. 3 is a schematic, planar view of a pixel unit of an electrophoretic display device in accordance with a second embodiment.

### DETAILED DESCRIPTION

Embodiments of the present disclosure will now be described in detail below, with reference to the accompanying drawings.

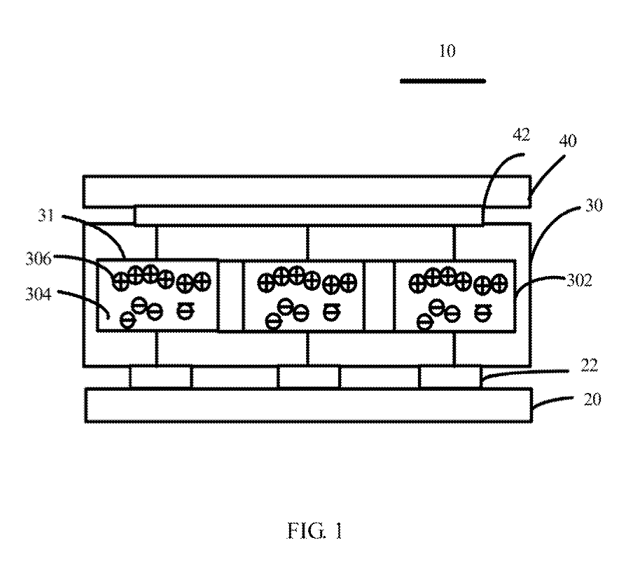

Referring to FIG. 1, an electrophoretic display device 10 includes a lower substrate 20, an electrophoretic ink layer 30, and an upper substrate 40. The electrophoretic ink layer 30 is arranged between the lower substrate 20 and the upper substrate 40. The upper substrate 40 is transparent and is used to protect the electrophoretic ink layer 30.

The lower substrate 20 can be made of plastic or glass. A plurality of pixel electrodes 22 is formed on the lower substrate 20. The pixel electrodes 22 are positioned between the electrophoretic ink layer 30 and the lower substrate 20.

A transparent electrode 42 is formed between the upper substrate 40 and the electrophoretic ink layer 30, which corresponds to a display surface of the upper substrate 40 to be viewed by a person such as an operator. In the embodiment, the transparent electrode 42 is grounded and is used as a common electrode and may be made of indium tin oxide.

The electrophoretic ink layer 30 includes a transparent film 31 and a plurality of grooves 302 defined in the transparent film 31. The grooves 302 are closed cavities and can be rectangular or tubular. Each groove 302 is located between one pixel electrode 22 and the transparent electrode 42, and contains transparent suspension fluid 304, and charged pigment particles 306 dispersed in the suspension fluid 304.

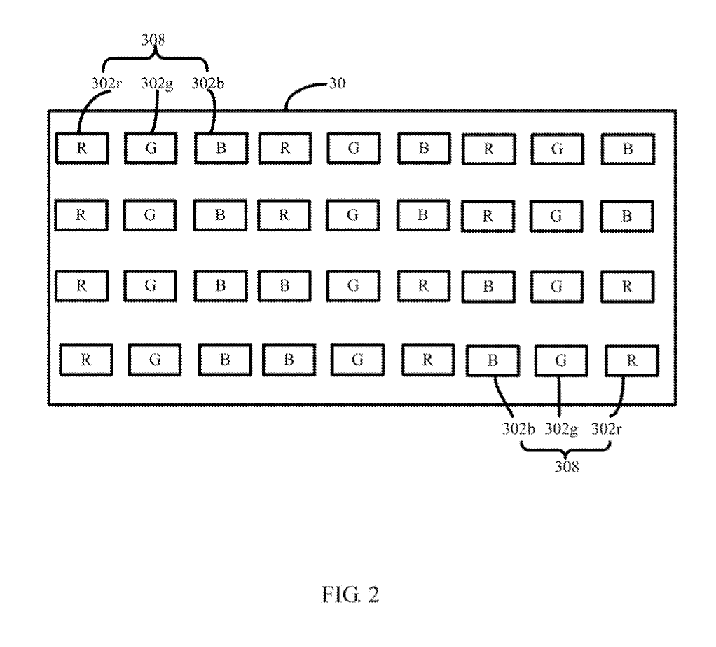

Referring also to FIG. 2, the grooves 302 are arranged in a matrix pattern and include first grooves 302r, second grooves 302g and third grooves 302b. One first groove 302r, one second groove 302g and one third groove 302b cooperatively constitute a pixel unit 308. The charged pigment particles 306 of the first, second and third grooves 302r, 302g, and 302b are red, green, and blue particles, respectively. The arrangement of the first, second and third grooves 302r, 302g, and 302b are not limited. For example, as shown in FIG. 2, the grooves 302r, 302g, and 302b are arranged from left to right in one pixel unit 308 in the upper left corner, while the grooves 302b, 302r, and 302g are arranged from left to right in another pixel unit 308 in the lower right corner.

Applying a voltage to the pixel electrodes 22 forms a corresponding electric field between the pixel electrode 22 and the transparent electrode 42. The charged pigment particles 306 of one groove 302 corresponding to the pixel electrode 22 are thus driven to move to or away from the transparent electrode 42 to form images displayed on the electrophoretic display device 10. If voltages of different amplitude are applied to one pixel electrode 22, different amount of charged pigment particles 306 are driven toward the transparent electrode 42 in response to the different voltage amplitude. The groove 302 corresponding to the pixel electrode 22 thus can display colors of different level accordingly. Therefore, the pixel unit 308 may display a mixed color combination of red, green, and blue; and the mixed color is changed, when the color levels of the first, second and third grooves 302r, 302g and 302b of the pixel unit 308, are changed.

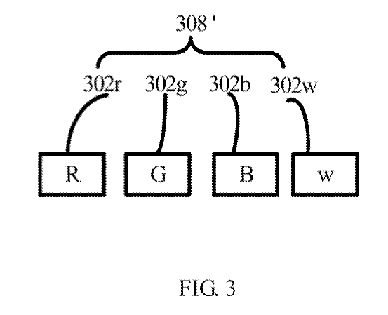

Referring to FIG. 3. In another embodiment, a pixel unit 308′ is constituted by the first groove 302r, the second groove 302g, the third groove 302b, and a fourth groove 302w. The charged pigment particles 306 of the fourth groove 302w are white particles. The pixel unit 308′ displays a mixed color combination of red, green, and blue, and white, which enhances the display contrast. In yet another embodiment, the charged pigment particles 306 of the fourth groove 302w are black particles, so that the pixel unit 308′ displays a mixed color combination of red, green, and blue, and black, which enhances the display saturation.

As shown in FIG. 3, the groove 302r, the groove 302g, the groove 302b, and the groove 302w constituting the pix unit 308′ are arranged from left to right in one row. In another embodiment, the first groove 302r, the second groove 302g, the third groove 302b, and the fourth groove 302w constituting the pix unit 308′ are arranged in a form of two rows and two columns.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electrophoretic display device, comprising:
a plurality of pixel electrodes;
a transparent electrode; and
an electrophoretic ink layer comprising a transparent film, a plurality of grooves being defined on the transparent film, each groove being arranged between one of the pixel electrodes and the transparent electrode, and comprising suspension fluid, and charged pigment particles dispersed in the suspension fluid.

2. The electrophoretic display device according to claim 1, wherein three grooves form a pixel unit, and the three grooves contain red particles, green particles, and blue particles, respectively.

3. The electrophoretic display device according to claim 1, wherein four grooves form a pixel unit, the four grooves contain red particles, green particles, blue particles, and white particles, respectively.

4. The electrophoretic display device according to claim 3, wherein the four grooves constituting the pix unit are arranged from left to right in one row.

5. The electrophoretic display device according to claim 3, wherein the four grooves constituting the pix unit are arranged in a form of two rows and two columns.

6. The electrophoretic display device according to claim 1, wherein four grooves form a pixel unit, and the four grooves contain red particles, green particles, blue particles, and black particles, respectively.

7. The electrophoretic display device according to claim 6, wherein the four grooves constituting the pix unit are arranged from left to right in one row.

8. The electrophoretic display device according to claim 6, wherein the four grooves constituting the pix unit are arranged in a form of two rows and two columns.

9. The electrophoretic display device according to claim 1, wherein the plurality of grooves is closed cavities.

10. The electrophoretic display device according to claim 9, wherein each of the grooves is rectangular shaped or tubular shaped.

11. The electrophoretic display device according to claim 1, further comprising a lower substrate and an upper substrate, the plurality of pixel electrodes being positioned on the lower substrate, and the transparent electrode being positioned between the electrophoretic ink layer and the upper substrate.

12. The electrophoretic display device according to claim 11, wherein the lower substrate is made of glass or plastic.

13. The electrophoretic display device according to claim 11, wherein the upper substrate is transparent.

14. The electrophoretic display device according to claim 1, wherein the transparent electrode is grounded and made of indium tin oxide.
